(19) United States
(12) Patent Application Publication
(10) Pub. No.: US 2014/0108256 A1
(43) Pub. Date: Apr. 17, 2014

(54) Electronic System for Quickly and Securely Processing Transactions Using Mobile Devices

(71) Applicant: Avance Pay AG, Belp (CH)

(72) Inventors: Heinz Bircher-Nagy, Belp (CH); Peter Danz, Bern (CH); Peter Kronegger, Graz (AT)

(73) Assignee: Avance Pay AG, Belp (CH)

(21) Appl. No.: 14/119,488

(22) PCT Filed: May 31, 2012
(86) PCT No.: PCT/EP2012/060293

§ 371 Date: Nov. 22, 2013

(30) Foreign Application Priority Data
May 31, 2011 (EP) 11405264.0

(51) Int. Cl. G06Q 20/14; G06Q 20/40

(52) U.S. Cl. CPC G06Q 20/14; G06Q 20/40
USPC 705/44

(57) ABSTRACT

The invention relates to a secured element (3) for securely and quickly processing transactions, said element being able to communicate with an external mobile device (1) and with an external billing center (6) such that transaction data (15) that is transmitted by the mobile device in order to authorize the transaction can be checked using authorization rules and parameters (8) of the billing center (6). According to the invention, the secured element (3) has a local proxy module (7) that acts on behalf of the billing center (6), wherein the current authorization rules and parameters (8) of the billing center (6) can be stored in said proxy module when communicating with the billing center (6) so that the proxy module (7) can authorize the transaction using the mobile device (1) in an autonomous manner, without a data connection to the billing center (6), and in a secured environment. The invention further relates to a method for securely and quickly processing a transaction between such a secured element, a mobile device (1), and a billing center (6).

The invention refers to a secured element for secure and fast transaction processing capable of communicating in such a way with an external mobile device and with an external billing center that transaction data transmitted from the mobile device for authorizing the transaction can be verified using authorization rules and parameters of the billing center. Furthermore, the invention refers to a method for the secure and fast processing of transactions, especially to a payment and/or authorization process between a secured element and an external mobile device, in which transaction data of the mobile device are verified with the help of authorization rules and parameters of an external billing center for authorizing the transaction.

Payment systems such as credit card terminals in supermarkets and gasoline stations are known in which the collection of transaction data takes place in a special, tamper-proof payment terminal and the authorization of the payment process is obtained online from the billing center in charge of accounting. The disadvantage of these systems is their long waiting time for authorization caused by establishing the connection with the center. These systems are too slow for fast payment processes. An additional disadvantage is the relatively high cost of the payment terminals because they generally are equipped with readers, PIN input keys, key memory and a processing unit. In addition, the entire device must be designed to be tamper-proof. Accordingly, the development, certification and manufacturing of payment terminals are expensive. Changes made to certified payment terminals or even their use for other applications are not allowed and would even be almost impossible owing to their tamper-proof design.

Ticketing systems for public transportation in big cities such as Paris, London or Tokyo—in which the booking process does not need a data connection to the billing center—are also known. This principle is used for fast transactions when travel authorizations must be checked. In this case, the logic for the booking process takes place in the terminal's processing unit. Owing to the cost involved, these terminals are almost unprotected against tampering. Another disadvantage of these systems is that expensive cash dispensers or automatic ticketing machines are needed for converting the fare into electronic travel authorizations. On the one hand, the high price of the terminals and automatic cash dispensers limits the widespread use of these systems and, on the other hand, a changeover of existing infrastructures as would be necessary for introducing new payment methods, for example, would require costly changes or the exchange of the hardware.

Also known from WO 2010/002541 A1 and US 2011/0022482 A1 are systems that attempt to create economical mobile payment systems using mobile telephones equipped with near field communications (NFC). All systems are either secured online (i.e. slow), or offline (i.e. inadequately). Thus, these systems have many of the disadvantages described above. Especially problematic are speed, handling, reduced security and insufficient standardization.

Also known is the method of incorporating security-relevant functions into integrated secured elements such as SIM cards. Integrated secured elements consist at least of a memory unit, a processing unit and a communication interface, integrated on a single chip and possibly with a cryptographic auxiliary central processing unit or other secondary units. Various security mechanisms protect the chip against tampering. Due to the high degree of tamper-proofing, integrated secure elements are used predominantly for saving and using keys and other sensitive data. Integrated secure elements are therefore used especially as means of payment, fare authorization tickets for public transportation, SIM cards for mobile phones and key memory, for example as secure access modules (SAM). The disadvantage of these application fields is that the counterpart for authorizing the integrated secure element is an online-connected central computer, which is unsuitable for the fast processing of transactions. In the case of fare authorization tickets for public transportation, the authorization for the fare takes place mostly offline, in the terminal's processing unit that is hardly tamper-proof.

A system from FR 2 921 786 A1 is known in which a secured element serves as SAM for authenticating tickets and a so-called security module is used for checking commands before they are sent to the ticket via NFC. In the first step, the ticket is authenticated by the SAM with pre-stored keys. Afterwards, the actual transaction process takes place by an applet, which runs in the unsecured area of the device. The debiting commands generated by this applet are then compared with the commands of a reference list in the security module of the NFC area before sending. If the command is not found in this reference list, the command is not sent and an optional negative message is issued to the user. Here, according to the system's description, the optionally encrypted reference list is stored typically in the NFC area at the time of manufacturing.

This system comprises at least three system components, namely the secured element (as SAM) for authenticating the ticket, the applet for processing the transaction in the device's unsecured central processing unit and the NFC part with a security module for comparing the sending commands with a reference list. The structure of this system slows down processing speed significantly owing to the communication paths determined by the hardware. In addition, security is not an integrated component of the transaction process but merely placed upstream by SAM's ticket authentication and respectively placed downstream by verification of the sending commands in the NFC part. The applet for processing the transaction runs in an unsecured environment and is therefore almost unprotected against tampering.

A system from WO 20081028989 A1 is also known in which a list in the secured element allows the device to have the corresponding counterpart available for any use registered in this list. Every time there is an installation or an application is updated, the list in the secured element is renewed. By means of the information contained in this list for an application, the device can obtain the respective counterpart through various channels and media. The comparison, however, takes place one-sidedly. Moreover, this takes place in the device itself and outside of the secured elements. For this reason, it is almost unprotected against tampering.

The invention presented has the purpose of greatly reducing the time needed for electronic transactions while ensuring a very high degree of security.

The task is solved by a secured element and a method for the fast and secure processing of transactions that has the characteristic of the independent patent claims.

The element secured according to the invention for the fast and secure processing of transactions has been designed with an external mobile device capable of communicating with an external billing center so that it can verify the transaction data transmitted by the mobile device for authorizing the transaction by means of the billing center's authorization rules and parameters. The transmitted transaction data are preferably the amount of the payment, temporal and/or spatial authorization information, user identification information, security features and/or account data. Representing the billing center, the secured element has a local proxy module. The proxy module has been executed so that when it communicates with the billing center, it can store the billing center's current authorization rules and parameters. Thus, the proxy module can authorize the transaction autonomously with the mobile device without communicating data to the billing center and in a secured environment. As a result of this, a very quick and secure processing of the transaction is ensured.

It is advantageous for the proxy module to be executed in such a way that it can be connected either with the external mobile device or with the external billing center at a certain point in time, especially by means of a communication interface of the secured element or of an electronic device or terminal intended for the purpose. Consequently, the proxy module or the communication interface of the secured element or of the electronic device or terminal intended for the purpose cannot be connected simultaneously with the mobile device and the billing center. Therefore, the proxy module can be connected especially via such an executed communication interface—only sequentially with the mobile device, namely at a first point in time in particular, and the billing center, namely at a second point in time in particular. Thus, the proxy module cannot connect in parallel or simultaneously with the mobile device and the billing center. This guarantees a high degree of security because the data comparison between transaction data and the authorization rules and/or parameters always take place in a secure environment, namely in the secured element or in the consequently also securely designed proxy module of the secured element.

Enhanced security can be secured if the proxy module is executed in such a way that it is capable of receiving the transaction data, especially temporal and/or spatial information, user identification information, security features and/or account data, from the external mobile device in an encrypted and/or signed way.

So the completed transactions can also be understood afterwards, it is advantageous if the proxy module is executed so that, for every transaction, it is capable of generating and storing (especially temporarily storing) accounting data (especially a transaction receipt), transaction confirmation data, payment parameters (preferably the amount of the payment), security features and/or account data.

It is advantageous if the proxy module is executed to be capable of transmitting—especially in an encrypted and/or signed way—the accounting data (especially the transaction receipt) to the mobile device. This allows the buyer to find out whether the transaction was successful and to know about completed transaction attempts or transactions made to his mobile device at a later point in time. Security can be enhanced by means of an encrypted and/or signed transmission.

To prevent unauthorized access, it is additionally advantageous if the authorization rules, parameters and/or accounting data can be transmitted in an encrypted and/or signed way to the billing center and/or can be compared with the billing center.

It is furthermore advantageous if the proxy module has a protected processing unit for evaluating transaction data, authorizing the transaction, generating accounting data and/or controlling the—preferably temporal—data transfer. This can ensure a high degree of security.

Regarding this, it is furthermore advantageous if the proxy module has a protected memory for storing authorization rules, parameters and/or accounting data.

It is advantageous if the secured element is designed as an SIM card and/or can be retrofitted into an electronic device, especially integrated into a mobile telephone, billing device and/or terminal. Thus, compatibility with standardized devices can ensure fast, economical and easy dissemination.

In the method according to the invention for fast and secure transaction processing, especially of a payment and/or authorization process, between a secured element and an external mobile device, transaction data of the mobile device for authorizing the transaction are checked by means of an external billing center's authorization rules and parameters. The secured element is preferably executed in accordance with the preceding description, in which case the features mentioned can be present either individually or in any combination. Moreover, the transaction data used primarily are the amount of the payment, temporal and/or spatial authorization data, user identification data, safety features and/or account data. The transaction authorization is carried out autonomously by a proxy module of the secured element, without data connection to the billing center. This ensures very fast and secure transaction processing.

Advantageously, at some point in time, the proxy module is connected either with the external mobile device or with the external billing center. The proxy module or the communication interface of the secured element or of the electronic device or terminal intended for this purpose cannot therefore be connected simultaneously with the mobile device and the billing center. Consequently, the proxy module can be connected only sequentially with the mobile device, especially via such executed communication interface, namely at a first point in time in particular, and with the billing center, namely at a second point in time in particular. Thus, the proxy module cannot possibly connect in parallel or simultaneously with the mobile device or the billing center. This ensures a high degree of security because the data comparison between transaction data and the authorization rules and/or parameters always takes place in a secure environment, namely in the secured element, or in the likewise securely designed proxy module of the secured element.

It is also advantageous if a data connection is established initially between the proxy module and the billing center and the latter's current authorization rules and parameters are stored in the proxy module, especially in its secured memory, to protect the sensitive authorization rules and parameters well against unauthorized access.

It is advantageous if at a later date—especially after the data connection between the secured element and the billing center has been separated—a data connection is established between the proxy module and the mobile device and the proxy module reads and/or writes the transaction data of the mobile device, especially payment parameters, preferably the amount of the payment, temporal and/or spatial authorization information, user identification information, safety features and/or account data. Therefore, transaction data can be checked for authorization in a secure environment, namely in a secure area of the secure element.

It is also advantageous for data security reasons if the transaction data are transmitted to the proxy module in an encrypted and/or signed way and the proxy module is capable of decoding them.

To prevent an unauthorized transaction, it is advantageous if the proxy module—especially a protected processing unit of the proxy module—checks the transaction data after the transaction has been authorized by means of the stored authorization rules and parameters.

It is also advantageous if the proxy module generates accounting data for each transaction, especially a transaction receipt, and it saves and/or temporarily saves and/or temporarily saves them, especially in a protected memory. This makes it possible to understand the completed transactions at a later point in time too.

It is advantageous if the proxy module transmits—especially in an encrypted and/or signed way—the accounting data, especially the transaction receipt, to the mobile device to improve the security of the system.

So the completed transactions can be verified, it is advantageous if the proxy module is connected to the billing center and the authorization rules, parameters and/or accounting data are compared with the billing center.

To prevent access of unauthorized persons, it is advantageous if the authorization rules, parameters and/or accounting data are transmitted in an encrypted and/or signed way to the billing center or are made available for transmission.

It is advantageous if new authorization rules and parameters are stored in the proxy module while the comparison takes place because the system's safety can be maintained at a high level for a long time.

In an advantageous further development of the invention, the local proxy module is implemented in an integrated secured element for the billing center. The proxy module can check payments and authorizations without data connection to the billing center and release or reject them. The integrated secured element is executed in various embodiments and, if needed, can be integrated into a mobile device—especially a terminal and/or mobile phone. The integrated secured element is, for example, simply a retrofitted part of a commercially available NFC mobile phone, which becomes a secure payment terminal as a result of this.

This is achieved because the proxy module makes available the rules for authorization or authorization rules and/or parameters of transactions such as those of payment processes, locally in the memory of the integrated secured element or of the proxy module. The evaluation of the transaction data, especially the amount of the payment, temporal and/or spatial authorization information, user identification information, security features and/or account data, and the authorization run also within the integrated secured element or proxy module, in its protected processing unit, which ensures maximum tamper protection.

Furthermore, the accounting data (such as transaction receipts, for example) are deposited in the memory of the integrated secured element or of the proxy module. Thus, a transaction can be processed quickly, securely and without data connection to the billing center. At a later point in time, when the data connection with the billing center is established, the accounting data and authorization rules, preferably parameters as well, are compared. This comparison takes place between the secured element especially the proxy module—and the billing center, which also ensures a maximum degree of protection against tampering during the comparison. The application in the integrated secured element in form of a chip card, SIM card, SD card or secure element can be simply distributed to existing mobile devices or terminals (to NFC mobile telephones, for example) owing to their standardization.

Advantageously, authorization speed can be increased by several orders of magnitude by the local proxy module. The implementation of these functions in an integrated secured element ensures a very high degree of protection against tampering, both during transaction processing and when the comparison with the billing center takes place. This makes it possible to have end-to-end security from the mobile device via the acting function or the proxy module in the secured element all the way to the billing center. The security is especially ensured because the transaction processing and the comparison take place in two separate steps at two different times.

The standardized forms of integrated secured elements allow the change-over of the infrastructure with existing NFC mobile telephones or other terminals/mobile devices. The autonomy of the integrated secured element from the means of payment and from the authorization, respectively, allows the proxy module to check them securely and independently. In short, the system can therefore be implemented very simply, economically and securely.

Advantageously, the transaction authorization takes place in the integrated secured element of the electronic system for the fast and secure processing of a transaction with a mobile device, in which case the proxy module authorizes the transaction without data connection to the billing center at a first point in time and compares authorization rules and parameters as well as accounting data such as transaction receipts, for example, with the billing center at a second point in time.

It is advantageous if the integrated secured element is integrated as hardware or software or mixed into a chip card, in a chip with additional functionality or in another way with a contactless, contact-based or multiply executed communication interface—for example into a payment card a phone card, an authorization card, a SIM card, a SAM, a memory card, an SD card, a bracelet, a wristwatch, a key holder, a dongle, an NFC chip, as an applet in a secured computer and/or controller, as secured applet in an unsecured computer or controller or in another specific hardware.

It is also advantageous if the proxy module is implemented as software or hardware or in a mixed way in the integrated secured element.

It is likewise advantageous if a chip card, a mobile telephone or a mobile device of another form with contact-free or contact-based or multiply executed communication interface is used as mobile device, for example in the form of a payment card, a phone card, an authorization card, a ticket, a SIM card, a memory card, an SD card, a bracelet, a wristwatch, a key holder, a dongle, an electronic agenda, a mobile phone and/or another mobile hardware.

Advantageously, this is about a payment transaction such as, for example, a credit payment, debit payment or value debiting, or an authorization transaction such as, for example, an access control, entry control or fare authorization control, or a mixed transaction that includes both a payment transaction and an authorization transaction.

It is also advantageous if the integrated secured element is integrated in form of a secure element or chip card, for example, into a certified or uncertified terminal or mobile device, for example into a mobile phone, tablet computer, chip card reading device, an RFD reader, a dongle, an electronic fare cancelling machine, a payment terminal, a sales device and/or into another specific terminal hardware.

Advantageously, the integrated secured element is supported by the mobile device, by a terminal, by a third device or by several of these devices during communication with the mobile device or when the transaction is being prepared with the mobile device or during subsequent processing or when the transaction with the mobile device takes place or when communication with the billing center takes place or during the comparison with the billing center.

In another advantageous further development of the invention, a part of the transaction data—for example, the amount of the payment, information about temporal or spatial authorization or a user identification—is gathered by input to the mobile device, the terminal, a third device and/or several of these devices or is otherwise somehow made available, for example, through keys, a touch screen or an input device for biometric characteristics.

It is advantageous if during transaction processing a secured (e.g. encrypted or signed) transaction receipt is transmitted to the mobile device, to the terminal, to a third device or to several of these devices, for the manual or automated checking or confirmation of the transaction.

It is also advantageous if the transaction result is communicated to the user via the mobile device, via the terminal, via a third device or via several of these devices, for example visually, haptically, acoustically or by allowing passage through an access barrier.

Advantageously, the communication takes place between the mobile device and the secured element in wireless, wired or mixed form, for example via ISO 14443, NFC, SWP, Bluetooth, USB or ISO 7816, directly or indirectly via the mobile device, via the terminal, via a third device, or via several of these devices, with the support of readers, controllers or computers, for example.

It is also advantageous if the communication between the secured element and the billing center takes place in wireless, wired or mixed form, for example via ISO 14443, NFC, SWP, Bluetooth, USB, ISO 7816, WLAN, cellular or Ethernet, directly or indirectly via the mobile device, via the terminal, via a third device or via several of these devices, with the support of readers, controllers or computers, for example.

Further advantages of the invention are described in the following embodiments. Other embodiments are absolutely possible and partially mentioned at the end of the description. The figures show:

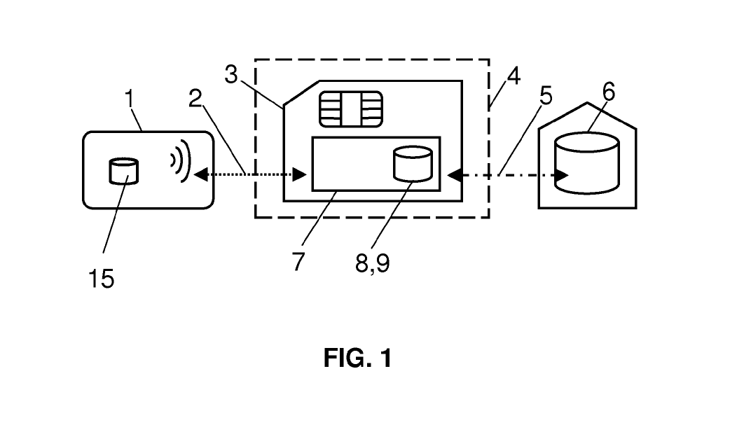

FIG. 1 a schematic representation of a payment process with a secured element according to the invention, and

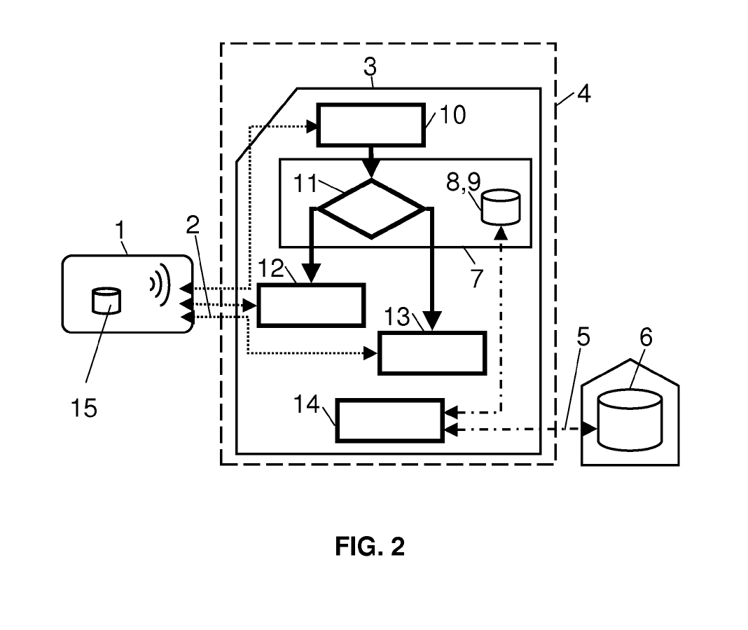

FIG. 2 an operating method of the invention integrated into the schematic overview of the system from FIG. 1.

The payment system shown in FIG. 1 comprises contactless payment cards as mobile device 1, as used also for electronic fare systems, for example. Transaction data 15, for example security features and information about the payer's or buyer's account, are stored on the contactless payment card or mobile device 1. In this embodiment, an SIM card is used as integrated secured element 3. The secured element 3 has a proxy module 7. The proxy module 7 is loaded either during initialization of the SIM card in a secure environment or securely transferred to the SIM card later via a trusted service manager. The proxy module 7 contains authorization rules and parameters 8 so it can authorize a transaction autonomously, in this case a payment. The SIM card or the secured element 3 is used in an electronic device or a terminal 4. Here, the terminal 4 is a commercially available mobile phone with NFC.

The terminal 4 or the secured element 3 or the proxy module 7 can be connected to a billing center 6 so it can communicate with it. The billing center 6 in charge of the account has a data server reachable via the Internet through data communication.

When the transaction begins, a seller enters the amount to be paid to the electronic device or terminal 4 or (in this case) mobile phone. By communicating at a first point in time 2 via the NFC of the mobile phone, the transaction data 15—especially security features and account information—are read by the contactless payment card. Afterwards, the first process step, namely the preparation of the transaction 10, is completed according to FIG. 2.

The data or transaction data 15 are subsequently checked by the proxy module 7 in accordance with FIG. 2 by means of the authorization rules and parameters 8 in a second process step, namely the authorization of the transaction 11. When the transaction release 12 or the transaction rejection 13 take place, the corresponding accounting data 9, namely a transaction receipt, is generated and saved by the proxy module 7. The transaction result is shown to the seller on a display of the mobile phone or terminal 4 (not shown here) and, if necessary, reported back to the payment card or mobile device 1 via NFC.

At another point in time, a comparison 14 takes place, in particular of the authorization rules and parameters 8, as well as of the accounting data 9 (i.e. of the transaction receipts) between the proxy module 7 and the billing center 6 via the data communication 5 of the mobile phone or terminal 4.

In this embodiment, the integrated secured element 3 could be integrated directly into the terminal 4 as secure element or in another form, for example as SD card. A contactless payment terminal could be used as terminal 4 instead of the mobile phone.

A mobile phone equipped with NFC and a payment application could also be used as payment card or mobile device 1. In this case, a contactless chip card could be used as integrated secure element 3. The communication to the payment application would take place via the NFC of the mobile device 1, and the communication 5 to the billing center 6 via NFC and the data communication of the mobile device 1. In this case, it could even be possible to do without the use of an autonomous terminal 4.

If the integrated secured element 3 is used in a conventionally built payment terminal, conventional payment cards with chip or magnetic strip could be also be authorized as mobile devices 1. Analogously to the payment systems mentioned above, a fare-payment system for public transportation or a ticketing system or mixed systems could be set up. Apart from the embodiments mentioned here directly, there are naturally many more embodiments possible.

This invention is not restricted to the embodiments shown and described. Variants within the framework of the patent claims are just as possible as a combination of characteristics, even if they are shown and described in various embodiments.

### LIST OF REFERENCE CHARACTERS

1 Mobile device
2 Communication at a first point in time
3 Secured element
4 Terminal
5 Communication at a second point in time
6 Billing center
7 Proxy module
8 Authorization rules and parameters
9 Accounting data
10 Preparation of the transaction
11 Authorization of the transaction
12 Release of the transaction
13 Rejection of the transaction
14 Comparison with the billing center
15 Transaction data

1. Secured element (3) for secure and fast transaction processing, capable of communicating with an external mobile device (1) and with an external billing center (6) in such a way,
that for authorizing the transaction it can verify the transaction data (15) transmitted from the mobile device by means of authorization rules and parameters (8) of the billing center (6),
characterized in that
the secured element (3) acting on behalf of the billing center (6) has a local proxy module (7),
in which the current authorization rules and parameters (8) of the billing center (6) can be saved when communication with the billing center (6) takes place, so that the proxy module (7) is capable of authorizing autonomously the transaction with the mobile device (1) without data communication to the billing center (6), and
in a secured environment.

2-20. (canceled)
